(19) United States
(12) Patent Application Publication
(10) Pub. No.: US 2006/0105125 A1
(43) Pub. Date: May 18, 2006

(54) Polyolefin resin and its use in films, coatings and food containers

(75) Inventors: Mike Musgrave, Houston, TX (US); John Ashbaugh, Houston, TX (US); LuAnn Kelly, Friendswood, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 10/989,747

(22) Filed: Nov. 16, 2004

(51) Int. Cl. B32B 27/32

(52) U.S. Cl. 428/35.2; 428/35.7

(57) ABSTRACT

A polyolefin resin, including a high crystalline polyolefin and a crystalline wax, may be used to prepare articles that are resistant to staining. In one embodiment, the resin is an admixture of high crystalline isotactic polypropylene and a polyethylene wax. The articles prepared therewith may be particularly resistant to food staining, including staining from contact with tomato products, and also resistant to scratching, odor adsorption, and distortion during heating.

### BACKGROUND OF THE INVENTION

1. Field of the Invention

The present invention relates to a polyolefin resin useful for preparing containers, films and coatings. The present invention particularly relates to a polyolefin resin useful for preparing stain resistant containers.

2. Background of the Art

The use of the microwave oven for preparing foods has created a need for non-metallic containers for cooking or food-warming that have resistance to both oily and aqueous foods at oven temperatures. Metallic containers such as aluminum trays do not efficiently cook foods in microwave ovens and may promote electrical arcing if the metallic container walls approach or touch the walls of the microwave oven. A suitable non-metallic food container should also withstand freezing temperatures and warming temperatures because foods sold in such containers will often be frozen and may be cooked or warmed in the container. Cooking times for foods stored in such containers usually range from a few seconds to a few minutes and cooking temperatures usually range from about 95° C. to 110° C., or even higher.

Non-metallic food containers are known. These are commonly manufactured using “commodity” resins such as polyethylene, polystyrene, and polypropylene. The containers produced using such resins have several desirable properties such as good economics, light weight, and in some cases exhibit good chemical resistance. For example, U.S. Pat. No. 6,459,075 to McCarthy, et al., discloses food contact articles prepared from low-odor, microwaveable, mineral-filled polypropylene. The articles are prepared by low temperature processing and typically include odor-suppressing basic organic or inorganic compounds. The articles are disclosed to be crack-resistant with synergistic amounts of polyethylene and titanium dioxide. However, odor is only one problem potentially encountered by polymers used in contact with food items.

Another problem encountered by non-metallic food containers manufactured using “commodity” resins is staining. Some food items may cause staining that greatly reduces the useful life of the containers that are used to store them. Stains from tomato products are described by the RUBBERMAID™ Company as the top consumer complaint in regard to plastic food containers. In an article dated Fall of 2002 and found on the internet at http://www.rubbermaid.com/hpd/stainshield/press/mediadetail.jhtml, there is disclosed a polycarbonate container that is described as being resistant to tomato product stains. These stain resistant containers are further described in WO 02/094560 A2 as being made, in part, of a polycarbonate engineering resin, i.e., a specially designed resin generally manufactured in small amounts for a limited number of applications. Unfortunately, such “engineering” resins are relatively expensive and do not provide the substantial economic benefits of using a so-called “commodity” resin, i.e., one that may be profitably manufactured in large quantities for a wide variety of applications, with the result that the per pound cost may be kept generally very low.

It would therefore be desirable in the art to provide a composition that uses a “commodity” resin and which has improved stain resistance performance as well as other desirable properties such as crack resistance, odor resistance, and light weight.

### SUMMARY OF THE INVENTION

In one aspect, the present invention is a polyolefin resin for use in preparing food containers. The polyolefin resin comprises a high crystalline polyolefin and from about 0.005 to about 1.5 percent by weight of a crystalline wax.

In another aspect, the present invention is an article for storing and/or heating food comprising at least two layers. One of the layers is a substrate and adhered thereto is a polyolefin layer. The polyolefin layer is prepared from a high crystalline polyolefin and from about 0.005 to about 1.5 weight percent crystalline wax.

### BRIEF DESCRIPTION OF THE DRAWING

For a detailed understanding and better appreciation of the present invention, reference should be made to the following detailed description of the invention and the preferred embodiments, taken in conjunction with the accompanying drawing, wherein:

FIG. 1 is a graph showing change in color after exposure to stain-producing material, plotted against wax concentration reported in weight percent based on weight of the high crystalline polyolefin.

### DETAILED DESCRIPTION OF INVENTION

In one embodiment, the invention is a polyolefin resin for use in preparing food containers, the polyolefin resin comprising high crystalline polypropylene and crystalline wax. Any olefin that may be polymerized to form a crystalline polymer may be used herein. In one embodiment, the crystalline polyolefin is high crystalline polypropylene.

High crystalline polypropylene is generally an isotactic configuration of polypropylene, often referenced using the term “i-PP.” The degree of crystallinity is an important parameter for establishing relationships between final product structure and mechanical strength, optical and thermal properties, and also for quality control and product specification. This crystallinity may be determined in a variety of ways. For example, solid state nuclear magnetic resonance spectroscopy [NMR] is one accepted method for absolute measurement of the crystallinity in polypropylene. This method is described in is K. Fujimoto, T. Nishi, and R. Kato, Polymer Journal, Volume 3, 448-462, 1972. Generally, energy is applied to the sample and the time needed for the sample to return from an excited higher energy state to ground state is monitored. This is called the Free Induction Decay curve. Crystalline regions decay much more quickly than amorphous regions, and thus, the curve may be mathematically analyzed by regions to quantify the crystalline and amorphous regions of the polymer.

Solution NMR is another technique used to characterize the level of crystallinity in a sample. In this method the percentage of isotactic pentads may be determined to assess the degree of crystallinity. Alternatively, the degree of crystallinity, average crystallite size and the extent of crystal lattice disorder may be determined using wide angle x-ray diffraction. Finally, differential scanning calorimetry “DSC” may be employed and is a particularly desirable and effective method for this purpose.

The inventive high crystalline polyolefin resins are, in the case of polypropylene, high crystalline polymers comprising propylene as the main monomer unit. Included in this group are high crystalline polypropylene homopolymers and high crystalline polypropylene polymers containing 2% by weight or less of alpha-olefins, such as ethylene and butene-1. The alpha-olefins contained in the high crystalline polypropylene polymers may be of two or more kinds in combination. These polypropylenes may be obtained using either Zieger-Natta or metallocene catalysts.

Regardless of how the degree of crystallinity of the high crystalline polypropylene is measured, it is the polymers' properties that will determine whether a given polymer is “high crystalline” as the term is used herein. The first property is melting point. In cases where the high crystalline polypropylenes are prepared using a Ziegler-Natta catalyst, they may have a melting point of from about 155° C. to about 170° C.

The second determining property is heat of fusion. Again, where they are Ziegler-Natta derived polymers, they may have a heat of fusion of at least 100 joules/g, and in many cases higher. For example, in one embodiment, they may have a heat of fusion of at least 115 joules/g. In another embodiment, they may have a heat of fusion of at least 120 joules/g. In yet another embodiment, the high crystalline polypropylenes of the present invention may have a heat of fusion of at least 125 joules/g. In yet another embodiment, the high crystalline polypropylenes may have a heat of fusion of at least 209 joules/g.

Finally, the Zieger-Natta derived high crystalline polypropylene resins also have a distinctive range of recrystallization temperature, which is from about 125° C. to about 135° C. This property is determined using a differential scanning calorimeter and a method such as is described in ASTM D-3417-99 wherein a 5 to 10 mg sample is heated and cooled at a rate of 10° C.

In the case of embodiments where the high crystalline polypropylenes are obtained using a metallocene catalyst, the high crystalline polypropylenes will have a melting point of at least about 158° C. They may also have a heat of fusion of at least 90 joules/g, and a recrystallization temperature of from about 105° C. to about 135° C. As for Ziegler-Natta derived polypropylenes, the crystalline properties of the metallocene catalyzed polypropylenes may also be assessed using a differential scanning calorimeter. Any metallocene derived polypropylene having these properties is a high crystalline polypropylene as the term is used herein. Exemplary high crystalline polypropylenes useful in the present invention include products designated as 3270 9119 from ATOFINA™, BP™ Accpro 9346, BASELLADSTIF™ HA722J, and SUNOCO™ PPF-050-HC.

In one embodiment, a polyolefin resin for use in preparing food containers comprises a high crystalline polypropylene and a crystalline wax. Crystalline waxes, sometimes referred to in the art as microcrystalline waxes, occur in petroleum oils in a wide range of molecular weights, melting points and other physical properties. By alteration of some refining procedures, wax fractions exhibiting a variety of properties and property combinations may be obtained. Synthetic crystalline waxes may also be used successfully herein. In general any crystalline wax may be selected, provided it has a melting point greater than about 100° C. More desirably the crystalline wax has a melting point greater than about 120° C. Such waxes may include polyethylene wax, for example, those polyethylene waxes having molecular weights of about 3000 daltons. Examples of useful commercial waxes include BP™ Polywax 3000, BP™ Polywax 2000, DIAMOND SHAMROCK™ wax, CROMPTON™ Moldpro 1031, LUBRIZOL™ PP Wax, and Clarian waxes.

The crystalline waxes and polyolefins useful with the present invention may be combined or compounded in any way known to be useful to those of ordinary skill in the art of preparing resins. For example the waxes and polyolefins may be coextruded. In one embodiment of the present invention, a resin is prepared by admixing the crystalline wax and polyolefin pellets together and then re-extruding the resulting admixture.

The inventive resins include as components at least a high crystalline polyolefin and a crystalline wax. In one embodiment, the crystalline wax is present in an amount from 0.005 to about 1.5 percent based on weight of the polyolefin. In another embodiment, the crystalline wax is present in an amount from about 0.1 to about 1 weight percent. In still another embodiment of the present invention, the crystalline wax is present in an amount of about 0.5 weight percent.

The inventive polyolefin resins may be used to prepare articles of manufacture for storing and/or heating food. In one embodiment such an article comprises at least two layers, wherein one of the layers is a substrate and the other layer is the inventive polyolefin which is adhered to the substrate. The article may be either a wrap or a three-dimensional container. In either case use of the inventive polyolefins provides valuable contributions to the performance of the article. Other articles that may be prepared using the inventive resins may include disposable food and drink containers, disposable food wraps, extrusion-coated papers and paper boards, co-extruded and blow-molded bottles, perfume dispensers, and the like.

In the case of a wrap, at least one layer that is a film of a conventional semi-crystalline polymer may be employed. This layer is the substrate and may impart physical properties to the wrap that are different from those contributed by the inventive resins. For example, during its use the wrap may be intentionally oriented such that its substrate layer is not in direct physical contact with the wrapped food or other material. In this orientation, the inventive resin may serve to protect the wrapped food or other material from potential detrimental effects that would be attributable to direct contact between it and the conventional polymer. For example, in one embodiment the article is a wrap that has two layers, a first layer of conventional semi-crystalline polypropylene and a second layer prepared from the inventive resin. In this case the substrate may impart desirable properties including resistance to cracking due to thermal stress during freezing and heating, while the layer formed from the inventive resin imparts other, also desirable properties such as stain resistance, odor resistance, and scratch resistance. The result may be a wrapped product that exhibits or benefits from, for example, lengthened shelf life, improved overall quality, and/or enhanced consumer acceptance.

In the case of three-dimensional containers, the inventive resin may be used in a multilayer construction that is similar to that of a wrap. A base material, functioning as a substrate, may be included in order to provide dimensional and thermal stability to the article. This base structure may be prepared of a conventional semi-crystalline material, again such as a conventional semi-crystalline polypropylene. The inventive resins may then be used to prepare a film or coating covering any surfaces of the three dimensional structure that will be in contact with food or other materials stored therein. In this type of construction the resin film or coating may function to provide stain resistance, odor resistance and scratch resistance.

The wraps and containers described hereinabove may be prepared in any way known to those of ordinary skill in the art to be useful for preparing such articles. For example, the wraps may be prepared by co-extruding the substrate material and the inventive resin. In one embodiment, the wrap may include an additional “tie” layer that serves to hold the substrate and resin layers together when there is insufficient compatibility between the layers for them to remain together without such “tie” layer. The tie layer may be an additional resinous layer, and as such may represent a film, coating, or adhesive. In the case of the three-dimensional containers, they may be injection molded, vacuum formed, or prepared by any process known to those of ordinary skill in the art to be useful for preparing such containers. Conventionally known processes for applying the inventive resin layer to the targeted surfaces of the substrate may be used. Examples of such methods include co-extrusion, lamination, casting, extrusion coating, and injection molding.

As discussed hereinabove, the inventive resins are useful in preparing articles that are resistant to staining and scratches, and which provide barrier protection with less heat distortion. Exemplary of such stains are the stains resulting from contact between a food storage container and a tomato-based food such as chili or spaghetti sauce. Tomatoes contain a class of compounds known as lycopenes. These compounds, while believed to have very desirable biochemical properties, are highly colored and, in combination with the oils also present in such foods, tend to migrate into the walls of containers prepared from many conventional polymers, particularly during the process of heating the foods in a microwave oven. The result is visually unattractive and may limit the reuse potential of the container.

While high crystalline polymers have been found to have some inherent resistance to staining by lycopene, the invention significantly improves on this resistance for a given high crystalline polymer. This improvement is likely attributable to a synergism between the high crystalline polyolefin and the crystalline wax. While not wishing to be bound by any theory, it is thought that the crystalline wax may serve to form crystalline structures in the non-crystalline portions of the polyolefin, thereby increasing the net crystallinity and barrier performance of the resin.

The protective layer formed by the inventive resin may be present in the articles of manufacture at very low levels. Polymers often have better physical properties when present in very thin layers. For example, a brittle polymer may be comparatively more flexible when it is extruded into very thin layers, in some cases ranging from 0.1 to 100 microns. Similarly thin films may be prepared for the inventive articles, with the result that in one embodiment, the inventive resin is less than or equal to about 2 percent of the total weight of the article. In another embodiment, the inventive resin is only about 0.2 percent by weight. In still another embodiment, the inventive resin is only about 0.1 percent by weight.

The inventive resins may be further admixed with other materials. For example, clarifiers and nucleators may be used with the inventive resins to improve the aesthetic appearance of the articles prepared therefrom. In another embodiment, a processing aid may be included to facilitate use of the resins in manufacturing procedures. For example, a variety of additives known to be useful to those of ordinary skill in the art of preparing containers, particularly food containers, may be used with the inventive resins. These may include plasticizers, colorants, thermal stabilizers, antioxidants, combinations thereof, and the like.

### EXAMPLE

The following example is provided for purposes of illustration. The example is not intended to limit the invention's scope and it should not be so interpreted. Amounts are in weight parts or weight percentages unless otherwise indicated.

### Example 1

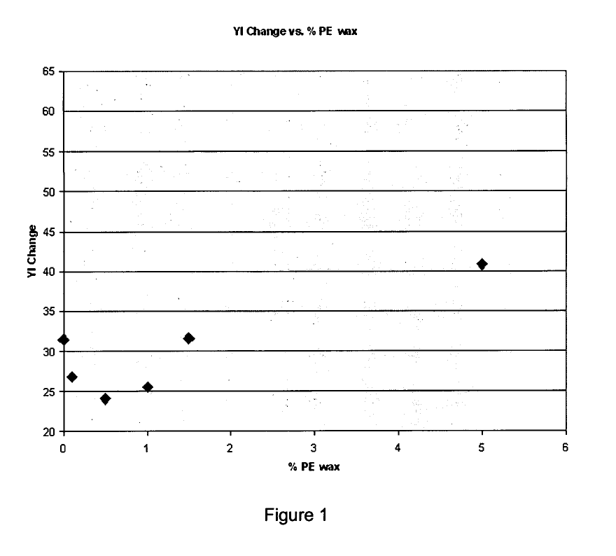

A resin is prepared using ATOFINA™ 3270, a high crystalline polypropylene (HCPP) homopolymer having a 2.0 ft/min melt flow rate. Portions of the HCPP homopolymer are compounded, using conventional methods, with varying amounts of a crystalline wax sold under the trade designation PE 3000 by BAKER PETROLITE™. The crystalline wax proportions range from 0 (a control and not an example of the invention) to about 5 weight percent based on weight of the homopolymer. The resulting compounded resins are tested for stain resistance to spaghetti sauce by first preparing experimental plaque-type samples having the dimensions×3.5 inches (8.9 cm)×1.5 inches (3.8 cm). The experimental samples are each suspended in RAGU® Chunky Garden Style spaghetti sauce with about 1.75 inches (4.4 cm) of each sample in contact with sauce. The samples and sauce are heated for about 7 minutes in a 1000 watt microwave oven, with the samples being rotated during the period of heating. The samples are removed and washed and the color change of each sample is measured using a DP-9000 Tristimulus Colorimeter available from Hunter Laboratories™. The results for each sample are plotted against the weight percent of the wax, as shown in the graph included herewith as FIG. 1.

As may be seen from the graph, the addition of a crystalline wax to the resin, in an amount of from about 0.005 to about 1.5 weight percent crystalline wax, results in substantially reduced staining.

What is claimed is:

1. A polyolefin resin for use in preparing food wraps and food containers comprising a high crystalline polyolefin and from about 0.005 to about 1.5 percent by weight of a crystalline wax.

2. The polyolefin resin of claim 1 wherein the high crystalline polyolefin is high crystalline polypropylene that is prepared using a Ziegler-Natta catalyst.

3. The polyolefin resin of claim 2 wherein the high crystalline polypropylene has a melting point of from about 155° C. to about 170° C.

4. The polyolefin resin of claim 3 wherein the high crystalline polypropylene has a heat of fusion of at least 100 joules/g.

5. The polyolefin resin of claim 4 wherein the high crystalline polypropylene has a heat of fusion of at least 115 joules/g.

6. The polyolefin resin of claim 5 wherein the high crystalline polypropylene has a heat of fusion of at least 120 joules/g.

7. The polyolefin resin of claim 6 wherein the high crystalline polypropylene has a heat of fusion of at least 125 joules/g.

8. The polyolefin resin of claim 3 wherein the high crystalline polypropylene has a recrystallization temperature of from about 110° C. to about 135° C.

9. The polyolefin resin of claim 1 wherein the high crystalline polypropylene is prepared using a metallocene catalyst.

10. The polyolefin resin of claim 9 wherein the high crystalline polypropylene has a melting point of at least 155° C.

11. The polyolefin resin of claim 10 wherein the high crystalline polypropylene has a heat of fusion of at least 90 joules/g.

12. The polyolefin resin of claim 10 wherein the crystalline polypropylene has a recrystallization temperature of from about 105° C. to about 135° C.

13. The polyolefin resin of claim 1 wherein the crystalline wax is a polyethylene wax.

14. The polyolefin resin of claim 13 wherein the polyethylene wax has a melting point greater than about 100° C.

15. The polyolefin resin of claim 14 wherein the polyethylene wax has a melting point greater than about 120° C.

16. An article for storing and/or heating food comprising at least two layers wherein one of the layers is a substrate and adhered thereto is a polyolefin layer wherein the polyolefin layer is prepared from a high crystalline polyolefin and from about 0.005 to about 1.5 percent by weight of a crystalline wax.

17. The article of claim 16 wherein the article is a wrap.

18. The article of claim 16 wherein the article is a three dimensional container.

19. The article of claim 18 wherein the article is selected from the group consisting of disposable food and drink containers, extrusion-coated papers and paper boards, co-extruded and blow-molded bottles, and perfume dispensers.

20. The article of claim 16 wherein the substrate is a semi-crystalline polyolefin.

21. The article of claim 16 wherein the high crystalline polyolefin is a high crystalline polypropylene that is prepared using a Ziegler-Natta or metallocene catalyst.

22. The article of claim 16 wherein the crystalline wax is a polyethylene wax.
